(19) United States
(12) Patent Application Publication
(10) Pub. No.: US 2015/0338677 A1
(43) Pub. Date: Nov. 26, 2015

(54) TENSIONED AND EXPANDABLES EYEGLASSES

(71) Applicant: Blockhouses, Inc., Atlanta, GA (US)

(72) Inventor: Jonathan David Block, Naivasha (KE)

(73) Assignee: Blockhouses, Inc., Atlanta, GA (US)

(21) Appl. No.: 14/286,283

(22) Filed: May 23, 2014

(51) Int. Cl. G02C 5/00

(52) U.S. Cl. CPC G02C 5/006

(57) ABSTRACT

Disclosed are various embodiments for an eyeglass band comprising a plurality of layers, wherein at least one of the layers comprises a bistable or multistable band and at least one layer comprises a lens. The eyeglass band, via the spring band, may be elongated in a first fixed position when tension within the springy metal bands is created. When the tension within the springy metal bands is lost, the flexible bistable spring band will cause the bistable eyeglass apparatus to change to either a second position or a third position. The lens may be in an eyelevel position when the eyeglass band is worn on a face of a wearer.

### BACKGROUND

Eyeglasses are generally rigid structures comprising frames with lenses worn in front of the eyes on the nose for vision correction or eye protection. The unyielding structure of traditional eyeglasses prohibits copious body motion, such as the motion produced during athletic events. For example, as eyeglasses are unable to conform to sudden changes in speed or motion, eyeglasses are prone to falling off the nose of the wearer resulting in damage to the eyeglasses as well as eliminated vision correction or eye protection to the wearer. As eyeglasses are generally bulky and fragile, safely carrying eyeglasses remains problematic.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an eyeglass band in various positions according to various embodiments of the present disclosure.

FIG. 2 is a drawing of the eyeglass band of FIG. 1 in a coiled position about a wrist of a wearer according to various embodiments of the present disclosure.

FIG. 3 is a drawing of the eyeglass band of FIG. 1 in a partially coiled position on a face of a wearer according to various embodiments of the present disclosure.

FIGS. 4A-B are drawings of the eyeglass band of FIG. 1 comprising a plurality of lens covers according to various embodiments of the present disclosure.

FIGS. 5A-C are drawings of a spring band that may be employed in the eyeglass band of FIG. 1 according to various embodiments of the present disclosure.

FIGS. 6A-C are drawings depicting exemplary layers of the eyeglass band of FIG. 1 according to various embodiments of the present disclosure.

FIGS. 7A-D are drawings depicting components that may secure the eyeglass band of FIG. 1 to a head of a wearer according to various embodiments of the present disclosure.

FIGS. 8A-B are drawings depicting securing components that may be employed in the eyeglass band of FIG. 1 according to various embodiments of the present disclosure.

FIGS. 9A-C are drawings depicting electrical and mechanical components that may be employed in the eyeglass band of FIG. 1 according to various embodiments of the present disclosure.

FIG. 10 is a flowchart illustrating one example of functionality implemented using at least the eyeglass band of FIG. 1 according to various embodiments of the present disclosure.

### DETAILED DESCRIPTION

The present disclosure relates to a multistable and flexible eyeglass band that may be used as eyeglasses. Eyeglasses are generally rigid structures comprising frames with rigid-type lenses worn in front of the eyes and on the nose for vision correction or eye protection. The unyielding structure of traditional eyeglasses prohibits copious body motion, such as the motion produced during athletic events. For example, as eyeglasses are unable to conform to sudden changes in speed or motion, eyeglasses are prone to falling off the nose of the wearer resulting in damage to the eyeglasses and eliminated vision correction or eye protection to the wearer. As eyeglasses are generally bulky and fragile, safely carrying eyeglasses remains problematic.

Multilayered apparatuses have enabled products with enhanced mechanical strength and new properties. For example, multilayered apparatuses may be employed to produce an object having a variety of states, wherein each state may have a useful function different from another state. Accordingly, it is beneficial to have a multilayered eyeglasses apparatus that is multistable, flexible, and capable of use in a variety of states.

According to various embodiments, an eyeglass band may comprise a plurality of layers, wherein at least one of the layers comprises a bistable or multistable band. According to various embodiments, the bistable or multistable band may comprise a flexible, bistable spring band, such as those employed in “slap” bracelets. Accordingly, the eyeglass apparatus, via the flexible, bistable spring band, may be elongated in a first fixed position when tension within the springy metal bands is created. When the tension within the springy metal bands is lost, the flexible bistable spring band will cause the bistable eyeglass apparatus to change to a second position and/or a third position. According to various embodiments, the spring band may be enclosed within one or more layers of various materials, as will be described in greater detail below.

An example operation of the bistable and flexible apparatus is described as follows. Assuming the bistable eyeglass apparatus is in a first position in which the bistable eyeglass apparatus is in an elongated, stationary position, a force may be induced in the apparatus to break the tension in the spring band (e.g., by slapping against a wearer's forearm, ankle, or similar surface), causing the spring band to naturally move to a potential second position and/or third position. To this end, the second position may comprise a state between the first fixed position (e.g., eyeglass band in an elongated, stationary position) and a third position (e.g., in a coiled position).

According to various embodiments, the second position may comprise a substantial portion of the band being elongated while the edges of the eyeglass band are coiled or otherwise curled such that, when positioned on the nose, the coiled edges fix to the temple of the wearer (hereinafter referred to as moderately coiled). One or more lenses may be configured in one or more layers of the eyeglass band such that, when the eyeglass band is in the second position on the nose, the eyeglasses are at eye level with the wearer, thereby providing vision correction and/or eye protection to the wearer. As may be appreciated, some use of the eyeglass band will not require placing the eyeglass band in the second position on the nose of the wearer. Accordingly, the second position is an optional position in various embodiments.

Upon removal of the eyeglass band from the nose, the eyeglass band may naturally move to the third position (e.g., coiled) or the band may be elongated such that it returns to the first position. In the third position in which the eyeglass band is coiled, the eyeglass band may be coiled around a variety of objects or limbs of a wearer, such as a forearm, wrist, leg, or ankle. By wrapping around the forearm or ankle in the third position, the eyeglass band is secured to the wearer. As may be appreciated, various motions may be produced by the wearer without the eyeglasses falling off of the forearm or ankle. The eyeglasses may be further secured in the third position (e.g., around the forearm or ankle), via a fastening component (e.g., nylon string, a hook and loop fastener, a button), as will be described in greater detail below. In the following discussion, a general description of the eyeglass band and its components is provided, followed by a discussion of the operation of the same.

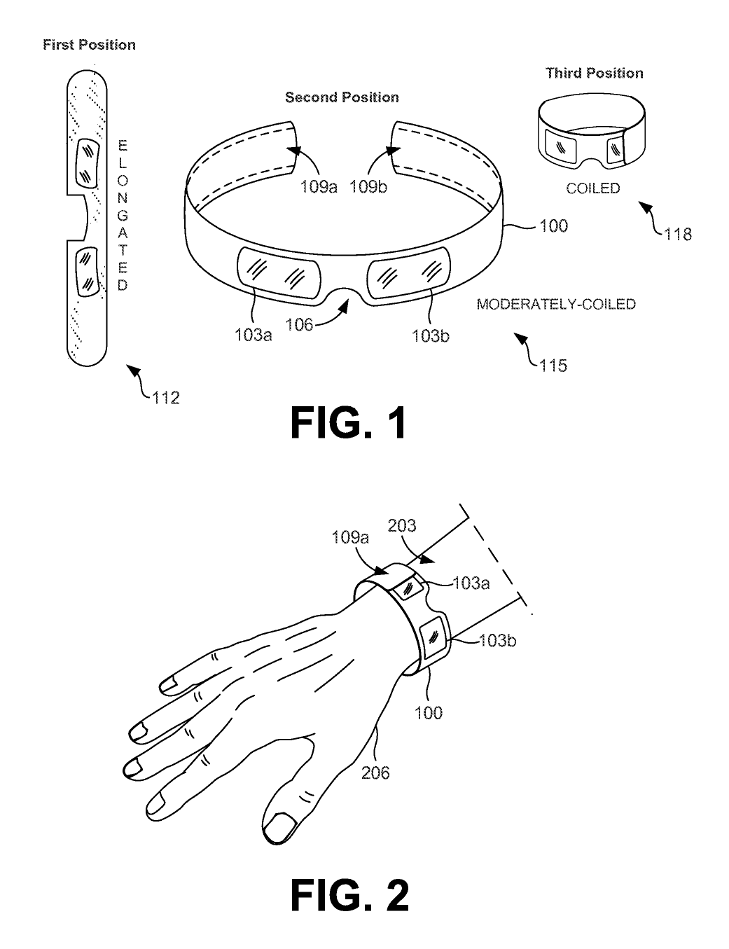

With reference to FIG. 1, shown is a non-limiting example of an eyeglass band 100 shown in various positions according to various embodiments of the present disclosure. As may be appreciated, the eyeglass band 100 may comprise a first lens 103a and/or a second lens 103b (collectively lenses 103). Although shown with two lenses 103, various embodiments may comprise the eyeglass band 100 having only one lens 103, such as embodiments where the eyeglass band 100 is employed as a magnifying glass (e.g., using a Fresnel lens). For embodiments where the first lens 103a or the second lens 103b are made up of a non-flexible material (e.g., plastic, polycarbonate, glass), the eyeglass band 100 may comprise a lens holder to facilitate a removal and an insertion of the lenses 103 without a dissection of the layers of the eyeglass band 100. For example, the lenses 103 may be configured to pop into a silicon lens holder (or similar lens holder).

As shown in FIG. 1, the eyeglass band 100 comprises a nose space 106 configured to conform to a nose of a human wearer, further facilitating a securement of the eyeglass band 100 on the human wearer. In various embodiments, the nose space 106 may not exist as a uniform bottom portion may come into contact with a nose of a human wearer. As may be appreciated, a first end 109a and a second end 109b may come into contact with portions of the head of the wearer, such as the temples (or a region of the head close to the temples), depending on the length of the eyeglass band 100 and the shape of the head of the wearer. To this end, the first end 109a and the second end 109b may provide additional support to the eyeglass band 100 when worn by the human wearer.

As discussed above, the eyeglass band 100 may comprise at least one layer having a bistable or multistable band (not shown). The bistable or multistable band may comprise a flexible, bistable spring band similar to those employed in “slap” bracelets. Accordingly, the eyeglass band 100, via the flexible, bistable spring band, may be elongated in a first position 112 when tension within the springy metal bands is created. When the tension within the springy metal bands is lost, the flexible bistable spring band will cause the eyeglass band 100 to change to either a variety of positions. For purpose of the disclosure submitted herein, the variety positions are denoted as a second position 115 and/or a third position 118 although more positions are possible and are intended to be within the scope of this disclosure. In the non-limiting example of FIG. 1, the tension within the spring band is lost and the eyeglass band 100 is in the second position 115 (“moderately coiled”) or in the third position 118 (“coiled”).

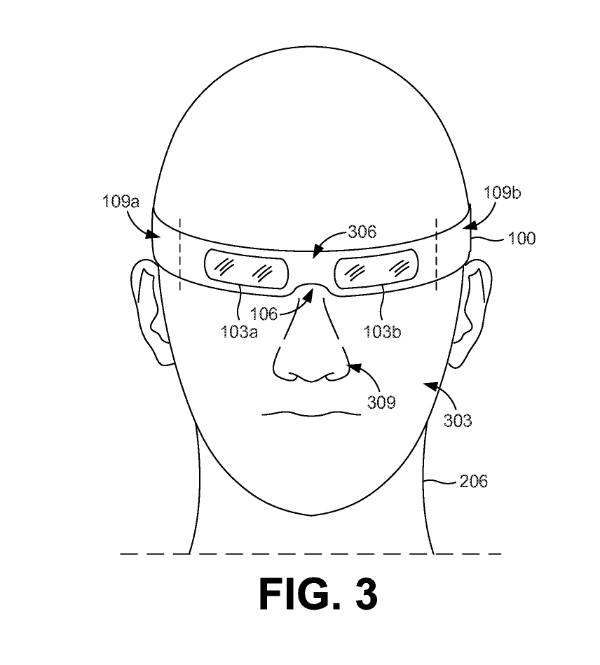

Moving on to FIG. 2, shown is a non-limiting example of the eyeglass band 100 of FIG. 1 in a fully coiled position about a wrist region 203 of a wearer 206. As shown in FIGS. 1-2, the eyeglass band 100 may transition to various positions while maintaining the integrity of the first lens 103a and the second lens 103b. For example, the eyeglass band 100 is able to transition without causing a lens 103 comprising of either a rigid or flexible material to tear, break, or pop out of the eyeglass band 100. As shown, a first end 109a of the eyeglass band 100 may wrap around the wrist region 203 with the second end 109b (FIG. 1) being coiled underneath the first end 109a such that the eyeglass band 100 fits securely around the wrist region 203 of the wearer 206. Although shown in a coiled position about the wrist region 203 of the wearer 206, the invention is not so limited. For example, the eyeglass band 100 may be capable of conforming to various regions of a human such as an arm, a leg, an ankle, etc., or various objects such as a tube of a bicycle frame, etc.

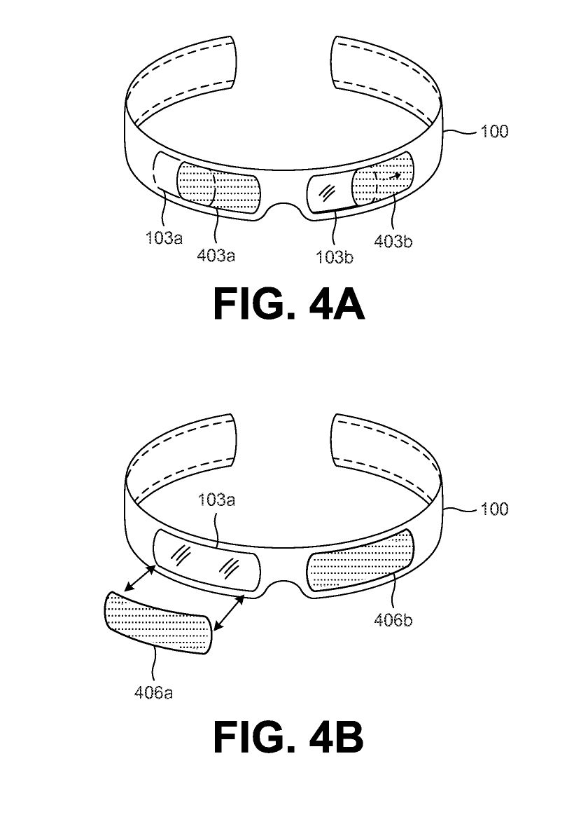

Turning now to FIG. 3, shown is a non-limiting example of the eyeglass band 100 in the second position 115 (FIG. 1) moderately coiled on a face 303 of the wearer 206 according to various embodiments of the present disclosure. As discussed above, the second position 115 of the eyeglass band 100 may comprise a substantial portion 306 of the eyeglass band 100 being elongated while the first end 109a and the second end 109b of the eyeglass band are slightly coiled or curled such that, when positioned on a nose 309, the coiled ends 109 fix to the temples of the wearer 206. The first lens 103a and the second lens 103b may be configured in one or more layers of the eyeglass band 100 such that, when the eyeglass band 100 is in the second position 115 on the nose 309, the lenses 103 are at eye level with the wearer 206, thereby providing vision correction and/or eye protection to the wearer 206.

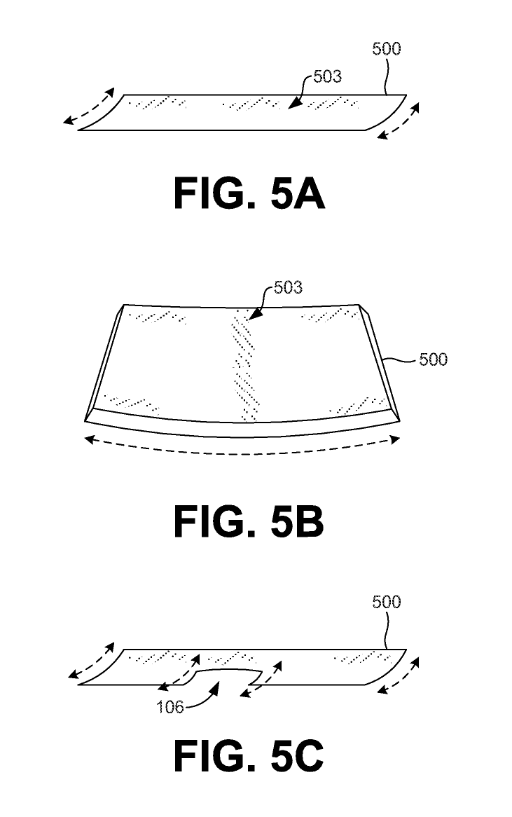

Moving on to FIGS. 4A-B, shown are non-limiting examples of the eyeglass band 100 comprising lens covers. Referring first to FIG. 4A, the eyeglass band 100 may comprise a first retractable lens cover 403a and a second retractable lens cover 403b (collectively retractable lens covers 403). As shown in FIG. 4A, and discussed above, the eyeglass band 100 may comprise the first lens 103a and the second lens 103b. As may be appreciated, flexible lens materials may be subject to scratching and tearing. Similarly, rigid-type lens, such as those utilizing optical crown glass, plastic, trivex, polycorbonate lens, etc., may be subject to scratching. To this end, the retractable lens cover 403 may comprise a suitable material such that the wearer 206 (FIG. 2) may position the retractable lens cover 403 to protect the one or more lenses 103 of the eyeglass band 100. When in use, the wearer 206 may position the one or more retractable lens covers 403 to slide into the interior of the eyeglass band 100. According to various embodiments, the retractable lens covers 403 may comprise at least one layer in the plurality of layers of the eyeglass band 100, as will be discussed in greater detail below. In various embodiments, the retractable lens covers 403 may comprise a translucent tint to add a sunglasses effect to the lenses 103 to provide additional protection from harmful UV rays. In other embodiments, the retractable lens covers 403 may comprise an opaque material to further protect the lenses 103 of the eyeglass band 100.

Referring next to FIG. 4B, the eyeglass band 100 may comprise a first removable lens cover 406a and a second removable lens cover 406b (collectively removable lens covers 406). As shown in FIG. 4B, the eyeglass band 100 may comprise the first lens 103a and the second lens 103b (not shown), wherein the removable lens covers 406 may “snap” or otherwise lock onto the eyeglass band 100 via the lens holder or via a removable lens cover holder, as can be imagined. As may be appreciated, the removable lens covers 406 may comprise a suitable material such that the wearer 206 may position the retractable lens cover 403 to protect the one or more lenses 103 of the eyeglass band 100. When the eyeglass band is not in use, the wearer 206 may remove the one or more removable lens covers 406 or the removable lens covers 406 may conform to the coiling of the eyeglass band 100. According to various embodiments, the retractable lens covers 403 may comprise at least one layer in the plurality of layers of the eyeglass band 100 as will be discussed in greater detail below. In various embodiments, the removable lens covers 406 may comprise a translucent tint to apply a sunglasses effect to the lenses 103 to provide additional protection from harmful UV rays. In other embodiments, the retractable lens covers 403 may comprise an opaque material to further protect the lenses 103 of the eyeglass band 100.

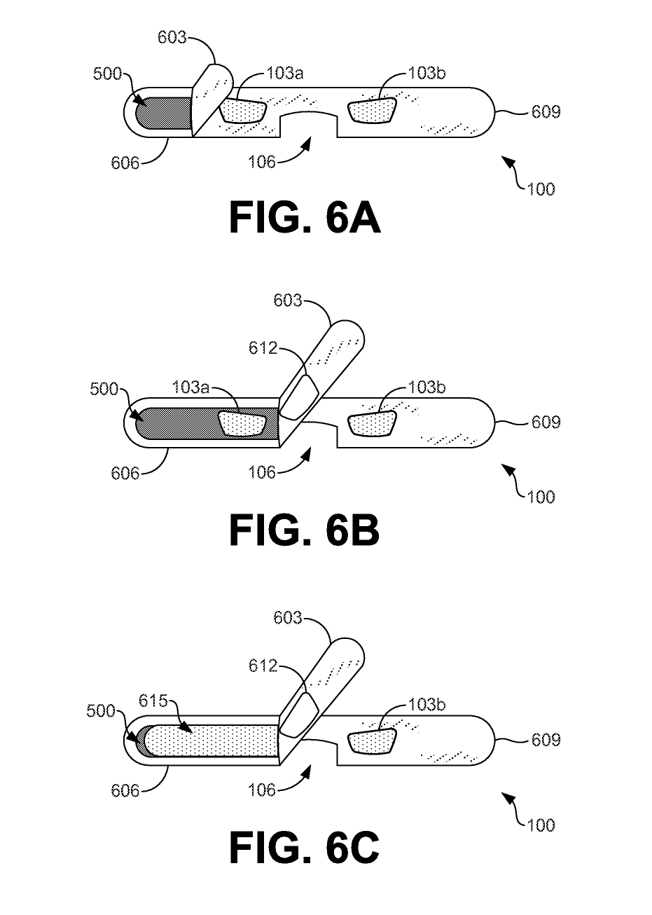

Referring next to FIGS. 5A-C, shown are examples of a spring band 500 that may be employed as a layer in the eyeglass band 100 (FIG. 1). According to various embodiments of the present disclosure, the spring band 500 may comprise a flexible substrate having a flat state and a curled state. When the eyeglass band 100 comprising the spring band 500 is elongated, a curve 503 is induced in the spring band 500 such that the spring band 500 maintains its elongated position. To this end, the spring band 500 may comprise a bistable steel spring band, a frame coated metal spring band, or any material with similar properties, employed as a layer of the eyeglass band 100. As shown in FIG. 5C, the spring band 500 may be formed such that the nose space 106 is created in a portion of the spring band 500 without impairing the ability of the spring band 500 to maintain its elongated or coiled positions. According to various embodiments, a portion of the spring band 500 may be removed to create the nose space 106, for example, after or during a manufacture of the spring band 500.

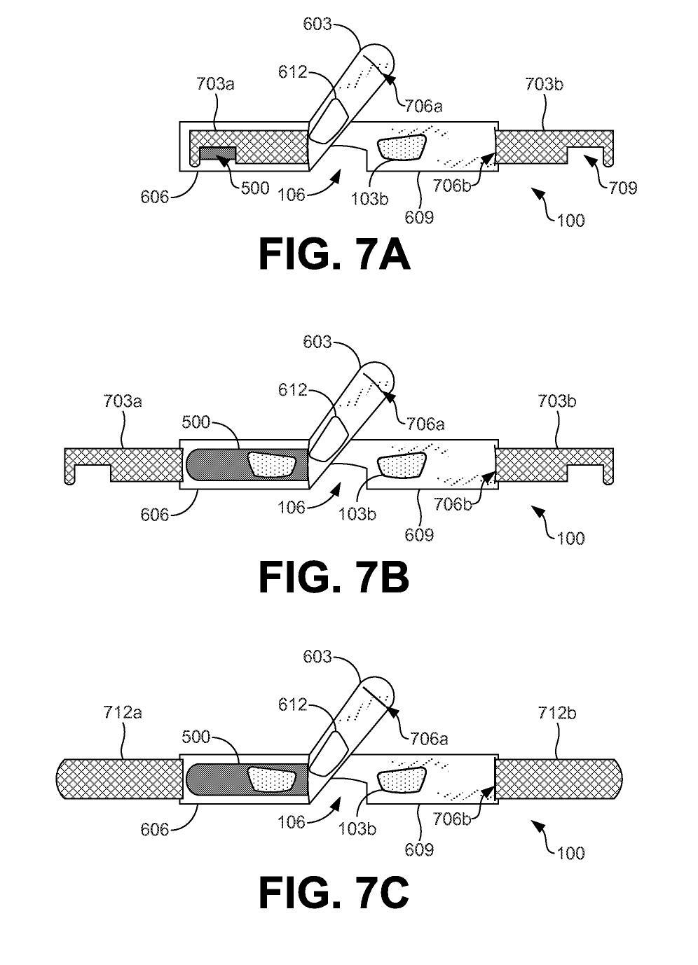

Turning now to FIGS. 6A-C, shown are non-limiting examples of the eyeglass band 100 of FIG. 1 comprising a plurality of layers according to various embodiments of the present disclosure. Referring first to FIG. 6A, shown is the eyeglass band 100 comprising a front layer 603, a back layer 606, and an intermediate layer comprising the spring band 500. As may be appreciated, the front layer 603, the back layer 606, and the spring band 500 may form a composite layer 609 giving the eyeglass band an appearance of a uniform layer. As may be appreciated, other layers may be employed in the eyeglass band 100. According to various embodiments, the front layer 603 and/or the back layer 606 may comprise various fabrics, plastics, carbon fiber materials, etc., as long as they are able to conform to (and not substantially obstruct) the positions induced by the spring band 500. In some embodiments, the front layer 603 and/or the back layer 606 may comprise a matrix of metal materials, such as a steel matrix, to provide additional strength to the structure.

As shown in FIG. 6B, the composite layer 609 may further comprise a layer for the first lens 103a and the second lens 103b. According to various embodiments, the first lens 103a and the second lens 103b may comprise a single, uniform layer. For example, in embodiments where the one or more lenses 103 comprise a cellophane or an acetate film, a single uniform film may be used as a single layer of the eyeglass band 100. However, in embodiments where the one or more lenses 103 comprise rigid-type lenses of a predefined size (e.g., prescription lenses), the composite layer 609 may be formed such that the rigid-type lens is securely fastened in a respective position of the eyeglass band 100.

As may be appreciated, rigid-type lenses may inhibit or impair the ability of the eyeglass band 100, via the spring band 500, to maintain its elongated or coiled positions. Accordingly, the spring band 500 may be of a size or material such that the curve 503 (FIG. 5) is capable of being preserved, thereby maintaining the elongated position of the eyeglass band 100. In the non-limiting example of FIG. 6B, the spring band 500 is shown as being larger vertically and horizontally than either the first lens 103a or the second lens 103b. The front layer 603 and the back layer 606 may be formed such that a hole 612 is predefined in each layer, thereby avoiding a disruption of a view of the one or more lenses 103. Similarly, the front layer 603 and the back layer 606 may be formed such that the nose space 106 is maintained.

In FIG. 6C, the composite layer 609 is shown comprising a uniform lens layer 615 for embodiments in which the first lens 103a and the second lens 103b comprise the same, flexible lens material. For example, the flexible lens layer 615 may comprise a cellophane film or an acetate film, such as those used in stereoscopic and three-dimensional (3D) glasses. Similarly, the flexible lens layer 615 may comprise a Fresnel lens magnifying film.

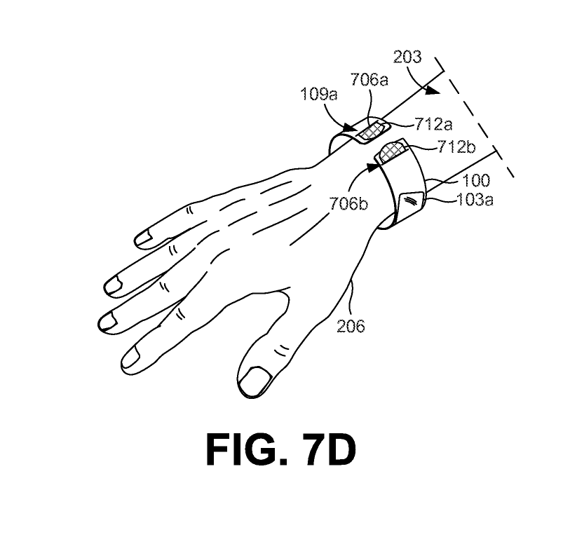

Moving on to FIGS. 7A-D, the eyeglass band 100 is shown comprising components that may secure the eyeglass band 100 to a head of the wearer 206 (FIG. 2) according to various embodiments of the present disclosure. Referring first to FIG. 7A, a first ear fastener 703a and a second ear fastener 703b (collectively ear fasteners 703) are shown that may be employed in various embodiments of the present disclosure. For example, the ear fasteners 703 may be utilized in securing the eyeglass band 100 on the head of the wearer 206 by connecting an ear space 709 with the top of the ears similar to traditional eyeglasses. In the non-limiting example of FIG. 7A, the first ear fastener 703a is positioned in the interior of the composite layer 609 and the second ear fastener 703b is positioned in the exterior of the composite layer 609. To this end, the wearer 206 of the eyeglass band 100 may pull either ear fastener 703 out of the interior or push either ear fastener 703 back in the interior. In the non-limiting example of FIG. 7B, the first ear fastener 703a and the second ear fastener 703b are located in a pulled-out position in the exterior of the eyeglass band 100. A first opening 706a and a second opening 706b (collectively openings 706) may be employed to position the ear fasteners 703 within or external to the eyeglass band 100 and further may facilitate a sliding motion of the ear fasteners 703 out of the interior of the eyeglass band 100. According to various embodiments, an insertion of the first ear fastener 703a and/or the second ear fastener 703b into the interior may serve a dual function of causing the ear fasteners 703 to act as lens covers for one or both lenses 103. According to various embodiments, the ear fasteners 703 may comprise a multistable spring body independent from one implemented as a layer of the eyeglass band 100.

In FIG. 7C, the eyeglass band 100 is shown comprising alternative components that may secure the eyeglass band 100 to a head of the wearer 206 (FIG. 2) according to various embodiments of the present disclosure. In the non-limiting example of FIG. 7C, a first temple fastener 712a and a second temple fastener 712b (collectively temple fasteners 712) are shown that may be employed in various embodiments of the present disclosure. For example, the temple fasteners 712 may be utilized in securing the eyeglass band 100 on the head of the wearer 206 by placing the temple fasteners at or around the temples of the wearer 206. Although shown in FIG. 7C as the first temple fastener 712a and the second temple fastener 712b being located in a pulled-out position in the exterior of the eyeglass band 100, the temple fasteners 712 may be positioned in the interior of the eyeglass band 100 utilizing the first opening 706a and the second opening 706b. According to various embodiments, an insertion of the first temple fastener 712a and/or the second temple fastener 712b into the interior may serve a dual function of causing the temple fasteners 712 to act as lens covers for one or both lenses 103. According to various embodiments, the temple fasteners 712 may comprise a multistable spring body independent from one implemented as a layer of the eyeglass band 100.

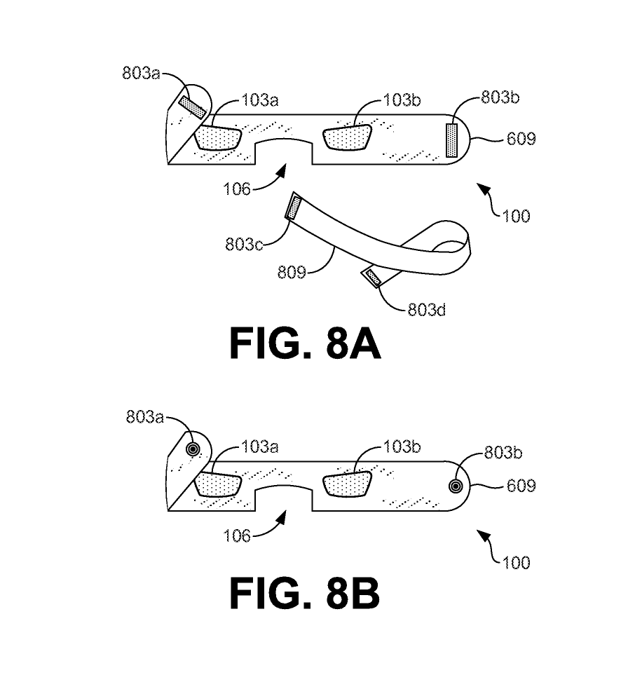

As shown in FIG. 7D, the first opening 706a and the second opening 706b are used to position the temple fasteners 712 in the interior of the eyeglass band 100 when not in use on the face of the wearer 206. As may be appreciated, the openings 706 facilitate the sliding motion of the temple fasteners 712a out of the interior of the eyeglass band 100. By employing retractable temple fasteners 712, the eyeglass band 100 may be shortened such that the ends 109 of the eyeglass band 100 do not overlap. This may facilitate embodiments in which a first end 109a is secured to the second end 109b of the eyeglass band, as will be discussed in greater detail below with respect to FIGS. 8A-B. Also shown in FIG. 7D, according to various embodiments, an outermost portion of the temple fasteners 712 (or ear fasteners 703) may always be exterior to the eyeglass band 100 to facilitate gripping the ear fasteners 703 by the wearer 206. In alternative embodiments, no portion of the temple fasteners 712 (or ear fasteners 703) may be visible when pushed into the interior of the eyeglass band 100 by the wearer.

Referring next to FIGS. 8A-B, shown is a first securing component 803a and a second securing component 803b that may be employed in place of, or in addition to, the ear fasteners 703 (FIG. 7) in the eyeglass band 100 according to various embodiments of the present disclosure. According to various embodiments, the first securing component 803a and the second securing component 803b may comprise loops configured to allow a band 806 to be tied to each loop. As may be appreciated, the band 806 may go around the head of the wearer 206 to further secure the eyeglass band 100 to the wearer 206.

In the non-limiting example of FIG. 8A, the first securing component 803a and the second securing component 803b may comprise a hook and loop fastener such as those manufactured by VELCRO®. As may be appreciated, the securing components 803 permit an extraneous band 809 to detachably attach to the eyeglass band 100, wherein the extraneous band 809 goes around the head of the wearer 206 to further secure the eyeglass band 100. To this end, the extraneous band 809 may comprise a third securing component 803c and a fourth securing component 803d, wherein the third securing component 803c may attach to either the first securing component 803a or the second securing component 803b and the fourth securing component 803d may attach to either the first securing component 803a or the second securing component 803b. In addition, in embodiments where the eyeglass band 100 is in a coiled position (e.g., about the wrist of the wearer 206 (FIG. 2)), the first securing component 803a may be configured to attach to the second securing component 803b, thereby further securing the eyeglass band 100 in the coiled position.

In the non-limiting example of FIG. 8B, the first securing component 803a and the second securing component 803b may comprise a button or similar a similar securing device. As may be appreciated, the securing components 803 may permit the extraneous band 809 to detachably attach to the eyeglass band 100 that may go around the head of the wearer 206 to further secure the eyeglass band 100. In addition, in embodiments where the eyeglass band 100 is in a coiled position (e.g., about the wrist of the wearer 206), the first securing component 803a may be configured to attach to the second securing component 803b, thereby further securing the eyeglass band 100 in the coiled position.

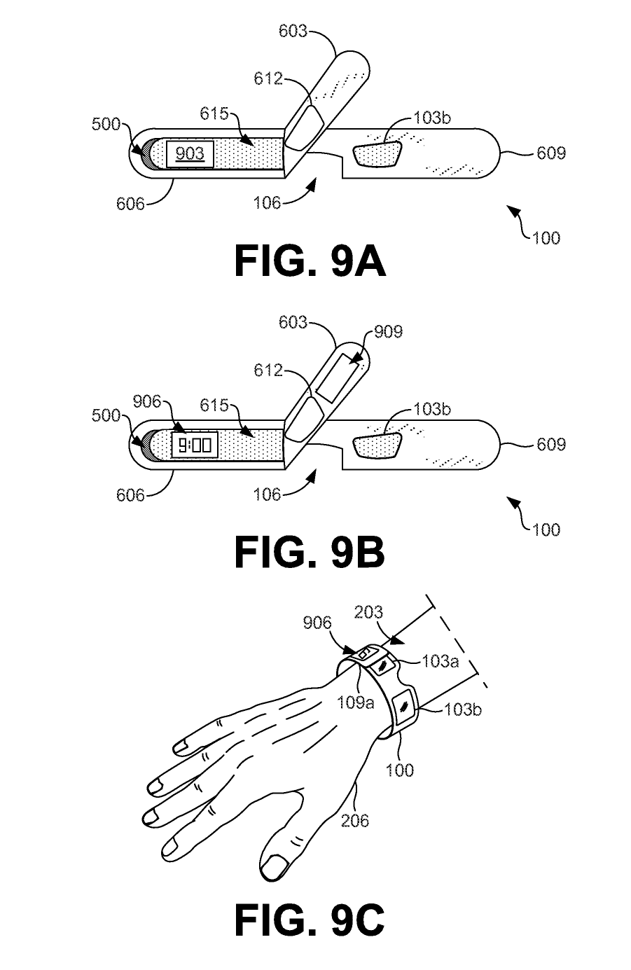

Moving on to FIG. 9A, the composite layer 609 of the eyeglass band 100 is shown in an embodiment comprising a circuitry component 903. According to various embodiments, the circuitry component 903 may comprise a battery, a digital clock, a gyroscope, a potentiometer, a blood pressure monitor, a heart rate monitor, a digital compass, a GPS module, a communication module, and/or any combination thereof. The communication module may comprise circuitry capable of communicating any data collected via the circuitry component 903 to an external computing device. To this end, the communication module may comprise a BLUETOOTH® module, a wireless fidelity (WiFi) module, a near field communication (NFC) module, a universal serial bus (USB) module, and/or any similar communication module capable of wired and/or wireless communication via an antenna.

Accordingly, the eyeglass band 100 may be configured to monitor steps taken, elapsed time, heart rate, blood pressure, etc., via the circuitry component 903 and be able to communicate the measured data via a communication component to a desktop computer, a tablet computing device, a smartphone computing device, etc. According to various embodiments, the circuitry component 903 may comprise a uniform, flexible layer in the eyeglass band 100. Alternatively, the circuitry component 903 may be located in a middle of the eyeglass band 100 or in a distal end of the eyeglass band 100, as shown in the non-limiting example of FIG. 9A. According to various embodiments, the circuitry component 903 may comprise flexible circuitry and/or flexible components capable of conforming to the positions of the spring band 500. According to various embodiments, the circuitry component 903 may comprise rigid circuits and/or rigid components that are capable of conforming to the positions of the spring band 500 in a respective portion of the eyeglass band 100 without interfering with the motion and/or use of the eyeglass band 100 as described herein.

Referring next to FIG. 9B, the circuitry component 903 (not shown) may further comprise a display 906. According to various embodiments, the display 906 may be a mechanical display (e.g., a clock or a compass) or a digital display (e.g., a light-emitting diodes (LED) display). According to various embodiments, the display 906 may comprise a flexible display capable of conforming to the positions of the spring band 500. According to various embodiments, the display 906 may comprise a rigid display that is capable of conforming to the positions of the spring band 500 in a respective portion of the eyeglass band 100 without interfering with the motion and/or use of the eyeglass band 100 as described herein. In FIG. 9C, the eyeglass band 100 is shown in a coiled position with the display 906 such that, when in the coiled position, the wearer 206 is capable of viewing the display.

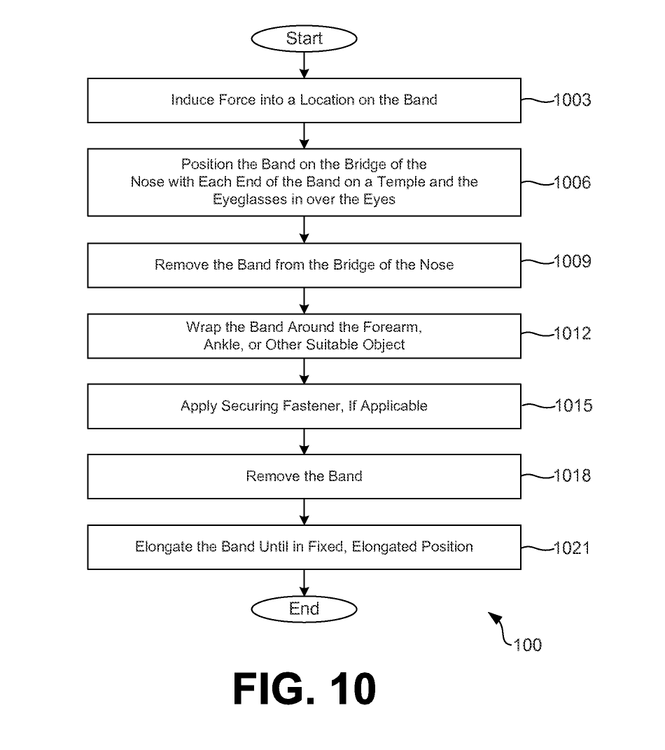

Referring next to FIG. 10, shown is a flowchart that provides one example of the operation of at least a portion of the eyeglass band 100 according to various embodiments. It is understood that the flowchart of FIG. 10 provides merely an example of the many different types of functional arrangements that may be employed to implement the operation of the at least a portion of eyeglass band 100 as described herein.

In 1003, assuming the multistable eyeglass band 100 is in a first fixed position in which the spring band 500 (FIG. 5) is in an elongated, stationary position, a force may be induced in a location of the eyeglass band 100 to break the tension in the spring band 500 (e.g., by slapping against a wearer's forearm, ankle, or similar surface), causing the spring band to naturally move to a second position and potentially a third position. To this end, the second position may comprise a state between the first fixed position (e.g., eyeglass band in an elongated, stationary position) and a third position (e.g., in a coiled position).

In 1006, the second position may comprise a substantial portion 306 (FIG. 3) of the eyeglass band 100 being elongated while the ends 109 (FIG. 1) of the eyeglass band 100 are slightly coiled or curled such that the ends 109 are capable of being secured to the temples of the wearer 206 and the nose space 106 (FIG. 1) is positioned on the nose 309 of the wearer 206. One or more lenses 103 (FIG. 1) may be configured in one or more layers of the eyeglass band such that, when the eyeglass band 100 is in the second position on the nose, the one or more lenses 103 are at eye level with the wearer 206, thereby providing vision correction and/or eye protection to the wearer. One or more securing fasteners may be applied to further secure the eyeglass band 100 in the wearable position. As may be appreciated, some use of the eyeglass band 100 will not require placing the eyeglass band 100 in the second position on the nose 309 of the wearer 206. Accordingly, the second position is an optional position in various embodiments.

In 1009, the wearer 206 may remove the eyeglass band 100 from the nose 309, causing the eyeglass band 100 (lacking tension via the force induced in 1003) may naturally move to the third position (e.g., coiled). Thus, in 1012, the eyeglass band 100, in the coiled position, may be placed around a variety of objects or limbs, such as a forearm, wrist, leg, or ankle of the wearer. By wrapping around the forearm or ankle in the third position, the eyeglass band is secured to the wearer. As may be appreciated, various motions may be produced by the wearer without the eyeglasses falling off of the forearm or ankle.

In 1015, a securing fastener may be applied to further secure the eyeglass band 100 in the coiled position. In 1018, the eyeglass band 100 may be removed from the limb or the similarly shaped object. In 1021, the eyeglass band 100 may be elongated such that the spring band 500 obtains the curve 503 returning the eyeglass band 100 to the first position.

Although the flowchart of FIG. 10 shows a specific order of execution, it is understood that the order of execution may differ from that which is depicted. For example, the order of execution of two or more blocks may be scrambled relative to the order shown. Also, two or more blocks shown in succession in FIG. 10 may be executed concurrently or with partial concurrence. Further, in some embodiments, one or more of the blocks shown in FIG. 10 may be skipped or omitted. It is understood that all such variations are within the scope of the present disclosure.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A flexible eyeglass band comprising:
a plurality of layers, at least one of the plurality of layers comprising a multistable spring body configured to transition from a first position to a second position to a third position, wherein the first position is an elongated position, the second position is a moderately coiled position, and the third position is a coiled position; and
wherein at least one of the plurality of layers comprises an eyeglass lens layer configured to conform to the multistable spring body during the transition from the first position to the second position to the third position, wherein, when worn in the second position by a wearer:
the eyeglass lens layer comprises at least one lens located at an eye level of the wearer; and
a first end and a second end of the flexible eyeglass band are positioned the temples of the wearer.

2. The flexible eyeglass band of claim 1, further comprising two ear fasteners, wherein each of the two ear fasteners is located at each end of the flexible eyeglass band.

3. The flexible eyeglass band of claim 2, wherein the two ear fasteners are capable of insertion into an interior of the flexible eyeglass band.

4. The flexible eyeglass band of claim 1, wherein the flexible eyeglass band is capable of a removal or an insertion of the at least one lens while the plurality of layers are attached.

5. The flexible eyeglass band of claim 1, wherein the flexible eyeglass band further comprises at least one lens cover configured to cover the at least one lens and to retract into at least one of the plurality of layers such that the at least one lens is visible to an environment.

6. The flexible eyeglass band of claim 1, wherein the flexible eyeglass band further comprises a space configured to conform to a nose when worn in the second position by the wearer.

7. The flexible eyeglass band of claim 1, wherein the multistable spring body further comprises a bistable spring steel body.

8. A system, comprising:
a plurality of layers of a flexible eyeglass band, at least one of the plurality of layers comprising a bistable spring body configured to transition from a first position to a second position to a third position, wherein the first position is an elongated position, the second position is a moderately coiled position, and the third position is a coiled position; and
wherein at least one of the plurality of layers comprises an eyeglass lens layer configured to conform to the bistable spring body during the transition from the first position to the second position to the third position, wherein, when worn in the second position by a wearer:
the eyeglass lens layer comprises at least one lens located at an eye level of the wearer; and
a first end and a second end of the flexible eyeglass band are positioned the temples of the wearer.

9. The system of claim 8, further comprising two ear fasteners, wherein each of the two ear fasteners is located at each end of the flexible eyeglass band.

10. The system of claim 9, wherein the two ear fasteners are capable of an insertion into an interior of the flexible eyeglass band, wherein the insertion of the two ear fasteners into the interior causes the two ear fasteners to act as a lens cover for the at least one lens.

11. The system of claim 8, wherein the flexible eyeglass band is capable of a removal or an insertion of the at least one lens while the plurality of layers are attached.

12. The system of claim 8, wherein the flexible eyeglass band further comprises at least one lens cover configured to cover the at least one lens and to retract into at least one of the plurality of layers such that the at least one lens is visible to an environment.

13. The system of claim 8, wherein the flexible eyeglass band further comprises a space configured to conform to a nose when worn in the second position by the wearer.

14. The system of claim 8, wherein the multistable spring body further comprises a bistable spring steel body.

15. A method, comprising:
inducing a force into a bistable steel spring body implemented as at least one of a plurality of layers in a flexible eyeglass band, wherein the inducement of the force causes the bistable steel spring body to transition the flexible eyeglass band from a first position to a second position to a third position, wherein the first position is an elongated position, the second position is a moderately coiled position, and the third position is a coiled position;
placing the flexible eyeglass band on a face of a wearer in the second position;
wrapping the flexible eyeglass band around the object in the third position; and
wherein at least one of the plurality of layers comprises an eyeglass lens layer configured to conform to the bistable steel spring body during the transition from the first position to the second position to the third position, wherein, when worn in the second position by the wearer:
the eyeglass lens layer comprises at least one lens located at an eye level of the wearer; and
a first end and a second end of the flexible eyeglass band are positioned the temples of the wearer.

16. The method of claim 15, further comprising placing two ear fasteners over ears of the object, wherein each of the two ear fasteners is located at each end of the flexible eyeglass band.

17. The method of claim 16, wherein the two ear fasteners are capable of an insertion into an interior of the eyeglass band, wherein the insertion of the two ear fasteners into the interior causes the two ear fasteners to act as a lens cover for the at least one lens.

18. The method of claim 15, further comprising removing the at least one lens in the eyeglass lens layer.

19. The method of claim 15, further comprising inserting the at least one lens into the eyeglass lens layer.

20. The method of claim 15, wherein the flexible eyeglass band further comprises a space configured to conform to a nose when worn in the second position by the wearer.
